(19) United States
(12) Patent Application Publication
(10) Pub. No.: US 2008/0256961 A1
(43) Pub. Date: Oct. 23, 2008

(54) Economized Refrigerant System with Vapor Injection at Low Pressure

(76) Inventors: Alexander Lifson, Manlius, NY (US); Michael F. Taras, Fayetteville, NY (US)

Correspondence Address: CARLSON, GASKEY & OLDS, P.C., 400 WEST MAPLE ROAD, SUITE 350, BIRMINGHAM, MI, 48009, US

(21) Appl. No.: 12/088,158

(22) PCT Filed: Oct. 20, 2005
(86) PCT No.: PCT/US2005/038152

§ 371 Date: Mar. 26, 2008

(51) Int. Cl. F25B 1/00; F04C 18/00; F16K 31/02

(52) U.S. Cl. 62/115; 62/498; 418/55.1; 251/129.15

(57) ABSTRACT

A refrigerant system with an economizer cycle incorporates a time dependant vapor injection scheme to reduce losses and enhance performance. The benefits of such an approach are particularly pronounced at low pressure ratios typical of air conditioning applications. The injection of refrigerant occurs during a limited time interval and at a particular point of time into a compression cycle. The vapor injection preferably occurs when the compression chamber are sealed (or about to be sealed off) from a suction port and continues until refrigerant pressure in the compression chambers is equal (or about to be equal) to the pressure at the injection line. This communication time constitutes about 35% of time of one revolution. In one embodiment, such time dependence of refrigerant vapor injection is provided by a specific compressor design. In another embodiment, a fast-acting solenoid valve is placed at the vicinity of the injection port to control the initiation and duration of the injection process. The benefits for an unloading scheme are disclosed as well.

### BACKGROUND OF THE INVENTION

This application relates to a refrigerant system being provided with vapor injection functionality such as by an economizer cycle, and wherein the vapor injection is limited to only the low pressure portion of the compression cycle.

Refrigerant systems are utilized in many applications to condition an environment. In particular, air conditioners and heat pumps are employed to cool and/or heat a secondary fluid such as air entering an environment. The cooling or heating load of the environment may vary with ambient conditions, occupancy level, changes in sensible and latent load demands, and as the temperature and/or humidity set points are adjusted by an occupant of the conditioned space.

Thus, refrigerant systems can be provided with sophisticated controls, and a number of optional components and features to adjust cooling and/or heating capacity. Known options include the ability to bypass refrigerant, which has been at least partially compressed by a compressor, back to a suction line. This function is also known as an unloader function. This additional step of operation is taken to reduce system capacity.

It is also known to utilize an economizer cycle. An economizer cycle provides system performance enhancement under certain conditions by tapping off a portion of a refrigerant flow downstream of a condenser. The tapped refrigerant is passed through a separate expansion device, and then through an economizer heat exchanger, in a heat transfer relationship with the main refrigerant flow that is flowing through a separate conduit within the economizer heat exchanger. In the context of this invention, as known in the art, a flash tank is also considered to be one type of an economizer heat exchanger. The tapped refrigerant cools the main refrigerant, such that the main refrigerant flow has a greater cooling potential when it reaches an evaporator. The tapped refrigerant is returned through a vapor injection line to an intermediate point in the compression cycle. As also known, economizer cycles can provide extra steps of unloading, while enhancing operation control and reducing life-cycle cost of equipment. Additionally, when an economizer cycle is combined with various means of compressor unloading, even greater benefits can be achieved.

One known system configuration with a scroll compressor utilizes the vapor injection line as part of the unloading operation. In this arrangement, a portion of refrigerant can be re-routed from the compression chambers into the vapor injection line, then through an unloader valve, and finally to a suction line leading to the compressor suction port.

In many vapor compression installations, and particularly in air conditioning applications with relatively low pressure ratios (ratio of compressor discharge pressure to compressor suction pressure), the economizer feature and the unloader feature, as described above, have not been fully utilized. Some reasons are related to the notion that in such low pressure ratio applications, the temperature difference in the economizer heat exchanger becomes very small to provide apparent benefits but pumping losses associated with the vapor injection line/port become more pronounced and are difficult to manage.

In the past, the injection line was in communication with compression pockets for most of the time during the compressor operation. For instance, in a scroll compressor, as a first scroll member orbits relative to a second scroll member, at some point in the orbiting cycle, the scroll wraps come together to seal the compression chambers from the suction port. The vapor injection into a scroll compressor occurs through an injection line that passes the refrigerant from an economizer heat exchanger or flash tank, into the intermediate injection point within the scroll compressor. The vapor is injected into a separate compression pocket typically sealed from suction and discharge ports. In the past, the vapor injection was timed to continue for majority of the scroll orbit cycle. The injection port would thus be exposed to almost a full range of pressure variation within the scroll compression pocket connected to the injection port. That led to two major pumping (sloshing) and throttling losses that were detrimental to the efficient compressor operation. These losses occurred because, at the beginning of the cycle, when the pressure in the scroll compression pocket was low, the injected refrigerant would fill the compression pocket. However, toward the end of the compression process, as the pressure within this compression pocket would increase, the refrigerant would be driven back into the injection line. This resulted in high sloshing losses as refrigerant moved in and out of the compression pocket. The throttling caused by the pressure drop in the injection line and through the injection ports would also contribute to the loss mechanism.

Overcoming this loss has proven to be a challenge for the incorporation of economizer cycles in such refrigerant systems for air conditioning applications, where any losses associated with the economizer cycle are extremely critical. The concept of combining the unloader line with the economizer cycle has also raised additional challenges. This occurs as the unloading operation can become less efficient then desired. During the system unloaded operation, when the vapor was returned back to the suction line from the intermediate compression port, too much compression power was consumed to compress the refrigerant to the higher pressure before it was bypassed back to suction. In particular, by the time a compressor has compressed the refrigerant to the point where the injection ports were closed off, a significant amount of power had been already wasted to compress the refrigerant that now was by-passed back to the compressor suction. Thus, compressor unloading has also not always been utilized successfully in the past.

The present invention is directed to addressing the above-described concerns.

### SUMMARY OF THE INVENTION

In a disclosed embodiment of this invention, a vapor injection line is only exposed to the compression chambers for a limited period of a compression cycle. In the prior art, the vapor injection has ordinarily been exposed to the compression chambers for a significant amount of time, typically more than 50% of the time during one revolution. In the present invention, the compression chambers are communicating with the vapor injection ports for less than 50% of the time during one revolution. More preferably, in a disclosed embodiment, the communication time is less than 35%. In one disclosed embodiment, a flow control device such as a fast-acting valve is placed on the vapor injection line in the vicinity of the vapor injection port to control the timing during which vapor injection will occur. A control will open and close this valve such that the valve only allows communication between the vapor injection line and the compression chambers for a short period of time during the scroll compressor orbit.

Thus, the present invention addresses the problems mentioned above.

These and other features of the present invention can be best understood from the following specification and drawings, the following of which is a brief description.

### BRIEF DESCRIPTION OF THE DRAWINGS

FIG. 1 shows a refrigerant system incorporating the present invention.

FIG. 1A shows an alternative arrangement.

FIG. 2 shows an example of vapor injection porting for a refrigerant compressor.

### DETAILED DESCRIPTION OF THE PREFERRED EMBODIMENTS

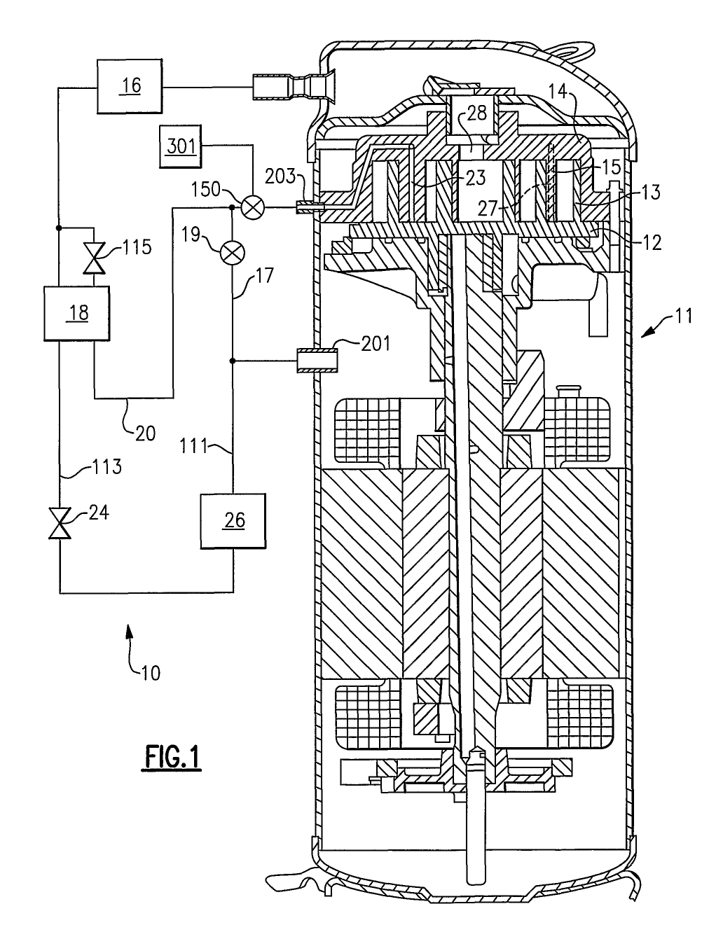

A refrigerant system 10 is illustrated in FIG. 1 including a compressor 11, an evaporator 26, a main expansion device 24, and a condenser 16. As is shown, an economizer heat exchanger 18 communicates through an economizer injection line (or so-called vapor injection line) 20 to the compressor 11.

The compressor 11 can be a scroll compressor having an orbiting scroll member 12 with a generally spiral wrap 13 and a non-orbiting scroll member 14 with a generally spiral wrap 15. As is well known, these wraps interfit to define compression chambers. As shown, as an example, the economizer injection line 20 communicates refrigerant into the compression chambers through the vapor injection ports 203 and wrap 15 of the non-orbiting scroll. The structure is generally as known.

The line 20 passes through an economizer expansion device 115, and then through the economizer heat exchanger 18. As is known, by passing a tapped refrigerant through the expansion device 115 and the heat exchanger 18 in heat transfer relationship with refrigerant in the main circuit, a refrigerant in a main liquid line 113 is cooled in the economizer heat exchanger. The economizer injection line 20 is shown returning the tapped refrigerant back to the compressor 11 at some intermediate point in the compression cycle, as known.

As further known, an optional unloader or bypass line 17 selectively communicates the economizer injection line 20 to a suction line 111. When an unloader valve 19 is opened, a portion of partially compressed refrigerant can pass from intermediate ports (described below) in the scroll members to the line 20, into the unloader line 17, through the unloader valve 19, and finally to the suction line 111. Suction line 111 communicates with a suction port 201 to deliver refrigerant back into the compressor 11. Typically, when the unloader valve 19 is opened the economizer expansion valve 115 is not in communication with a vapor injection port 203. In case the expansion valve 115 is not equipped with a shutoff capability, an additional shutoff device may be placed on the economizer injection line 20 to isolate it form the vapor injection port 203 of the compressor 11. Again, this structure and flow configuration is as known.

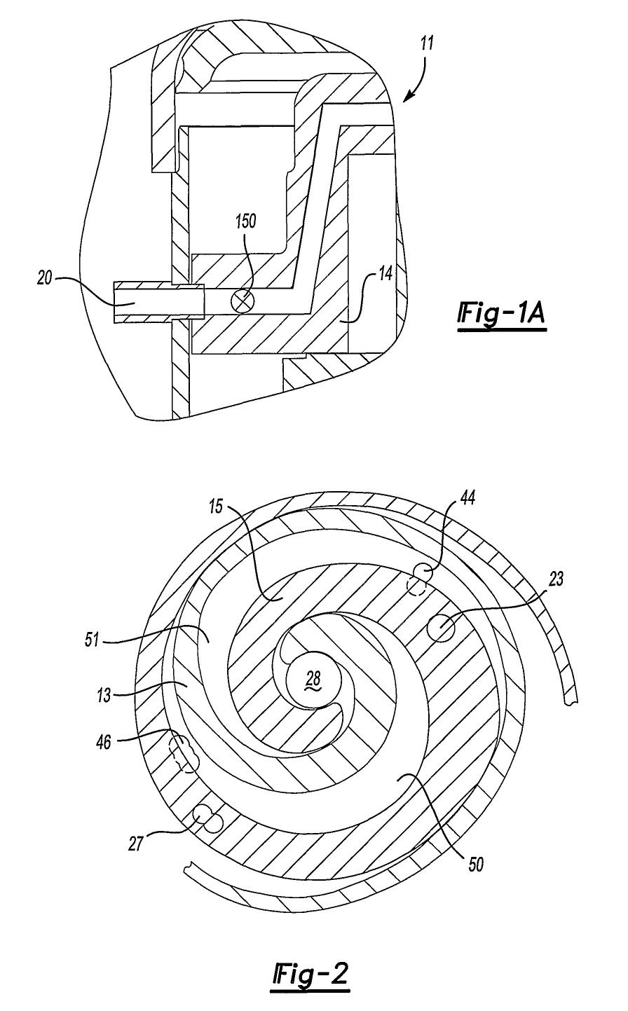

As shown in FIG. 2, the non-orbiting scroll wrap 15 is preferably a “hybrid type” and as shown has a varying thickness along its circumferential extent. As shown in this example, the injection ports 23 and 27 are formed through the wrap 15. The injection ports 23 and 27 may have a varying size. Further, the injection ports 23 and 27 are preferably formed at a part of the wrap 15, at the location, which is not of its minimum thickness. The thicker wrap portion provides additional assurance that injection ports of sufficient size can be formed through the wrap. As shown a discharge port 28 is formed through a rear face of the fixed scroll, as known. The injection ports can also be formed through the floor of the fixed scroll as known in the art.

An orbiting scroll includes a wrap 13 which can also be of the “hybrid type”, and which extends from a base. The base includes grooves 44 and 46 formed on the scroll floor.

During the operation of the scroll compressor, the orbiting scroll 12 will move relative to the non-orbiting scroll 14, such that the base of the orbiting scroll 12 will slide over the tip of non-orbiting scroll wrap 15. For the configuration shown in FIG. 2, the injection ports 23 and 27 communicate with the grooves 44 and 46 when they overlap during the compression cycle. At this point, injection of the economized refrigerant flow into the compression chambers 50 and 51 may take place. It is desirable to provide communication between the injection ports 23 and 27 and the compression chambers via, for example, grooves 44 and 46 when the refrigerant pressure in the compression chambers 50 and 51 is below the pressure in the economizer injection line 20. Under such conditions, the economized refrigerant flow is directed into the compression chambers 50 and 51. It is also important to minimize or avoid communication between the injection line 20 and the compression chambers 50 and 51 when the pressure in the compression chambers 50 and 51 rises above the refrigerant pressure in the economizer injection line 20. As a result, pumping (sloshing) of refrigerant “in and out” of the chambers 50 and 51 is avoided. Finally, it is often important to provide the abovementioned refrigerant communication shortly after the compression chambers 50 and 51 are sealed off (or about to be sealed off) from the suction port 201 of the compressor 11, to achieve maximum temperature differential in the economizer heat exchanger 18. It should be noted that what is presented in FIG. 2 is an example of how the flow through the economizer ports can be selectively blocked or unblocked at specific instants of time during the compression cycle. Other arrangements in positioning of the economizer injection ports that allow for a limited injection time are also possible. Consequently, the arrangement shown in FIG. 2 is presented for the illustration purposes only.

If the timing of the injection process needs additional enhancement to what is described in the arrangement shown in FIG. 2., then as shown in FIG. 1, a fast-acting flow control device such as valve 150 can be placed on the economizer injection line 20. This valve can be controlled by a system controller 301 such that it is only opened soon after the scroll wraps 15 and 13 come into the contact or are just about to come into the contact to seal the compression chambers 50 and 51 from the suction port 201. The valve 150 is closed well before the compression chambers 50 and 51 communicate with the discharge port 28 and at the point when the refrigerant pressure in the compression chambers is still preferably below or equal to the refrigerant pressure in the economizer injection line 20. In essence, the timed opening of the valve 150 in FIG. 1 serves similar purpose as the “valving on” and “valving off” of the injection ports 23 and 27 by the grooves 44 and 46 in FIG. 2. This valve 150 can be used in conjunction with an arrangement shown in FIG. 2 or independent of this arrangement. It has to be understood that the valve 150 can be located internal or external of the compressor shell. An external location is exhibited in FIG. 1. Alternatively, the valve 150 can be internal of the shell as shown in FIG. 1A. The valve can also be attached to the shell.

In the disclosed embodiments, the vapor injection ports 23 and 27 are only communicating with the compression chambers 50 and 51 for less than 50% of the time of the compression cycle. In a preferred disclosed embodiment, this communication time is less than 35%. Precise timing of such communication results in efficiency improvement of the economizer cycle. It has also been found that when the system operates in the non-economized mode (both the economizer branch is turned off and the by-pass line is closed) the average pressure in the injection line would not exceed 1.75 times the suction pressure, especially if the vapor injection ports and vapor injection line begin to communicate shortly after the compression chambers 50 and 51 are sealed off. This low pressure in the injection line also results in more efficient operation of the system in the non-economized mode.

In a similar manner, the efficiency of the by-pass unloading operation is also improved when the valve 19 is open and a portion of the partially compressed refrigerant is by-passed back to the compressor suction port 201. Since the refrigerant is by-passed early in the compression process, the unnecessary over-compression of the by-passed refrigerant causing additional power draw is avoided.

It has to be understood that a system designer may consider different priorities regarding system performance improvement, with the emphasis on capacity or efficiency. Although both approaches will benefit from the disclosed invention, the vapor injection initiation should start as early as possible from the capacity boost perspective but should coincide with a capacity-power optimum (still located in a low pressure region) for the efficiency enhancement. In other words, in the latter case, an efficiency optimum should be found between the capacity increase due to a larger temperature difference in the economizer heat exchanger and additional power consumption due to an injected refrigerant flow being compressed by the compressor.

While the particular disclosed embodiment is shown for a scroll compressor, other type compressors such as screw compressors, rotary compressors, reciprocating compressors or any refrigerant compressor that may incorporate an economizer cycle can utilize the present invention.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A refrigerant system comprising:
a compressor for compressing refrigerant and delivering a refrigerant downstream to a condenser, an expansion device downstream of said condenser, an evaporator downstream of said expansion device, refrigerant passing from said compressor to said condenser, to said expansion device, to said evaporator, and being returned to a suction line for said compressor;
an economizer cycle including a tap tapping a portion of refrigerant from a main refrigerant flow in a liquid line and passing said tapped refrigerant through an economizer expansion device, and then through an economizer heat exchanger, said tapped refrigerant exchanging heat with said main refrigerant flow in said economizer heat exchanger, and tapped refrigerant being returned to said compressor through an injection line; and
the compressor having a compressor pump unit, said compressor pump unit being driven through a compression cycle, a suction port, and a discharge port, and said compressor pump unit being operable to receive refrigerant, and compress the refrigerant toward the said discharge port, said compressor communicating injection of refrigerant from said injection line into said compressor pump unit and into at least one injection port, and a time of said injection being less than 50% of the time period of one compressor revolution.

2. The refrigerant system as set forth in claim 1, wherein said time of said injection is less than 35% of the time period of one compressor revolution.

3. The refrigerant system as set forth in claim 1, wherein said compressor pump unit consists of at least one compression pocket connected to said injection line.

4. The refrigerant system as set forth in claim 3, wherein said injection line starts communicating with at least one compression pocket at any time within the time interval of one tenth of one compressor revolution before any compression pocket is exposed to the suction port and two tenth of the one compressor revolution after any compression pocket is isolated from the suction port.

5. The refrigerant system as set forth in claim 1, wherein the timing of the said injection is controlled by selectively blocking and unblocking said injection line.

6. The refrigerant system as set forth in claim 5 wherein said blocking and unblocking is controlled by a flow control device

7. The refrigerant system as set forth in claim 6, wherein said flow control device is positioned outside of said compressor.

8. The refrigerant system as set forth in claim 6, wherein said flow control device is positioned inside of said compressor.

9. The refrigerant system as set forth in claim 6, wherein said flow control device is controlled by a system controller.

10. The refrigerant system as set forth in claim 6, wherein said flow control device is a fast-acting solenoid valve.

11. The refrigerant system as set forth in claim 5, wherein said blocking and unblocking is controlled by opening and closing of the said at least one injection port.

12. The refrigerant system as set forth in claim 11, wherein said opening and closing of the said at least one injection port is controlled by grooves on the floor of the orbiting scroll.

13. The refrigerant system as set forth in claim 1, wherein said injection line also communicates with an unloader line, said unloader line being provided with an unloader valve, and such that said unloader valve may be opened to allow for at least a portion of partially compressed refrigerant to move back through said injection line to said suction port.

14. The refrigerant system as set forth in claim 1, wherein said compressor pump unit is a scroll compressor.

15. The refrigerant system as set forth in claim 1, wherein said compressor operates at pressure ratios of discharge pressure to suction pressure between 2 and 8.

16. The refrigerant system as set forth in claim 1, wherein said compressor has a pressure ratio of pressure in said injection line to suction pressure below 1.75 when the injection line and unloader lines are blocked off.

17. A method of operating a refrigerant system comprising the steps of:
providing a compressor pump unit, said compressor pump unit being provided with a suction port, and a discharge port, and said compressor pump unit being operable to receive suction refrigerant, and compress the suction refrigerant toward the discharge port through a compression cycle; and
said compressor also being provided with an injection line to communicate an injection of refrigerant into said compression chambers during said compression cycle, and said injection of refrigerant being limited to 50% of the time period of one compressor revolution.

18. The method of operating a refrigerant compressor as set forth in claim 17, wherein said injection of refrigerant is limited to 35% of the time period of one compressor revolution.

19. The method of operating a refrigerant compressor as set forth in claim 17, wherein an unloader line includes a valve that is selectively opened to allow flow of refrigerant from compression chambers through said injection line, and back to said suction port.

20. The method of operating a refrigerant compressor as set forth in claim 17, wherein the compressor pump unit is a scroll compressor.

21. The method as set forth in claim 17, wherein said compressor operates at pressure ratios of discharge pressure to suction pressure between 2 and 8.

22. The method as set forth in claim 17, wherein said compressor has a pressure ratio of pressure in said injection line to suction pressure below 1.75 when the injection line and unloader lines are blocked off.
